(19) United States
(12) Patent Application Publication
(10) Pub. No.: US 2024/0288463 A1
(43) Pub. Date: Aug. 29, 2024

(54) SOLVENT STORAGE DEVICE AND LIQUID TRANSFER SYSTEM

(71) Applicant: SHENZHEN JINGTAI TECHNOLOGY CO., LTD., Shenzhen, Guandong (CN)

(72) Inventors: Jianqing LIU, Shenzhen, Guandong (CN); Yang LIU, Shenzhen, Guandong (CN); Jiandong GAO, Shenzhen, Guandong (CN)

(21) Appl. No.: 18/573,306

(22) PCT Filed: Jun. 13, 2023
(86) PCT No.: PCT/CN2023/099906

§ 371 Date: Dec. 21, 2023

(30) Foreign Application Priority Data
Jun. 14, 2022 (CN) 202210665998.1

(51) Int. Cl. G01N 35/10; B01L 3/00; G01N 35/00; G01N 35/04

(52) U.S. Cl. CPC G01N 35/1002; B01L 3/565; G01N 35/0099; G01N 2035/0496; G01N 2035/0498

(57) ABSTRACT

A solvent storage device and a liquid transfer system. The solvent storage device is provided with at least one layer of a frame which has a receiving chamber with an opening. A container carrying assembly for carrying containers is arranged in, and the container carrying assembly is provided with a plurality of container placement parts. The container carrying assembly is connected to the frame through a first moving mechanism for driving the container carrying assembly to move in a straight line at the opening. Accordingly, the space occupied by a plurality of containers can be reduced and the liquid transfer operation is more convenient.

### CROSS-REFERENCE TO RELATED APPLICATIONS

The present application claims priority to Chinese Patent Application No. 202210665998.1 filed with the China National Intellectual Property Administration on Jun. 14, 2022, entitled SOLVENT STORAGE DEVICE AND LIQUID TRANSFER SYSTEM, the contents of which are all incorporated herein by reference in their entireties.

### FIELD OF THE INVENTION

The present disclosure relates to automation equipment technology, in particular to a solvent storage device and a liquid transfer system.

### DESCRIPTION OF THE RELATED ART

In the process of automated biochemical sample preparation and analysis, it is often necessary to use a liquid transfer pump to transfer liquid from a container. The process of liquid transfer involves operations such as taking and opening of bottles, liquid pump-out, and closing and placing of the bottles. As the number of types of solvent increases, more containers need to be used, resulting in a larger space occupied by the containers. Moreover, operating a plurality of containers one by one lead to longer liquid transfer time.

### SUMMARY

To solve or partially solve the problems existing in the related art, a solvent storage device and a liquid transfer system are provided to reduce the space occupied by a plurality of containers and make the liquid transfer operation more convenient.

In the first aspect, the present disclosure provides a solvent storage device. The solvent storage device is provided with at least one layer of a frame which has a receiving chamber with an opening. A container carrying assembly for carrying containers is arranged in the receiving chamber, and the container carrying assembly is provided with a plurality of container placement parts;
wherein the container carrying assembly is connected to the frame through a first moving mechanism for driving the container carrying assembly to move in a straight line at the opening.

In an implementation, a container sealing assembly is arranged in the receiving chamber and is connected to the frame through a second moving mechanism;
wherein the container sealing assembly includes a sealing mechanism corresponding to the container placement part, and the second moving mechanism is configured to drive the sealing mechanism to be close to or away from the container placement part so as to make the sealing mechanism be in seal fit with or separate from a mouth of the container.

In an implementation, the first moving mechanism includes a first guide component and a first drive assembly, the container carrying assembly is slidably connected to the first guide component, and the first drive assembly is in transmission connection with the container carrying assembly to drive the container carrying assembly to move; and/or
the second moving mechanism includes a second guide component and a second drive assembly, the container sealing assembly is slidably connected to the second guide component, and the second drive assembly is in transmission connection with the container sealing assembly to drive the container sealing assembly to move.

In an implementation, the container carrying assembly includes a transverse moving plate and a container limit plate installed above the transverse moving plate, the transverse moving plate is slidably connected to the first guide component, and the first drive assembly is in transmission connection with the transverse moving plate;
wherein the container placement part includes a limit hole formed in the container limit plate, and the container is hold in the limit hole and supported on the transverse moving plate.

In an implementation, the container sealing assembly includes a longitudinal moving plate and a mounting plate installed to the longitudinal moving plate, the longitudinal moving plate is slidably connected to the second guide component, the second drive assembly is in transmission connection with the longitudinal moving plate, and the sealing mechanism is installed to the mounting plate.

In an implementation, the sealing mechanism includes a guide column installed to the mounting plate, the guide column has a sealing component installed thereon, the sealing component is arranged corresponding to the container placement part and is configured to be engaged with the mouth of the container.

In an implementation, the sealing component is movably arranged along an axial direction of the guide column, an elastic member is sleeved on the guide column, and both ends of the elastic member are abutted against the mounting plate and the sealing component respectively.

In an implementation, the sealing component includes a support sheet sleeved on the guide column and a sealing sheet tightly engaged with the support sheet, and the both ends of the elastic member are abutted against the mounting plate and the support sheet respectively;
wherein the sealing sheet is located below the support sheet, and a lower surface of the sealing sheet is configured to be engaged with the mouth of the container

In an implementation, the mounting plate has a mounting hole formed therein, the guide column is installed in the mounting hole, an upper end of the guide column is connected to a first fastener, the first fastener presses against an upper side of the mounting plate, a lower end of the guide column is connected to a second fastener, the sealing component is sandwiched between the second fastener and the elastic member, and the second fastener presses against one side of the sealing component that is away from the elastic member.

In an implementation, the first drive assembly includes a first motor and a first drive rod that cooperates with the first motor in a transmission manner, the first motor is fixed to the frame, and the first drive rod is arranged horizontally and connected to the transverse moving plate to drive the transverse moving plate to move; and/or
the second drive assembly includes a second motor and a second drive rod that cooperates with the second motor in a transmission manner, the second motor is fixed to the frame, and the second drive rod is arranged longitudinally and connected to the longitudinal moving plate to drive the longitudinal moving plate to move.

In an implementation, the container sealing assembly is provided with a plurality of said sealing mechanisms which are in one-to-one correspondence with to a plurality of said container placement parts.

In an implementation, the container limit plate is spaced from the transverse moving plate in a vertical direction;
wherein in the case that the container is hold in the limit hole, a bottom of the container is supported on an upper surface of the transverse moving plate and an outer side wall of the container presses against a wall of the limit hole.

In an implementation, the frame includes a bottom plate, a top plate, and a side plate and a back plate connected between the bottom plate and the top plate, wherein the bottom plate, the top plate, the side plate, and the back plate define the receiving chamber, and the opening is arranged on an opposite side of the back plate.

In an implementation, the solvent storage device is provided with a plurality of layers of said frame which are fixedly or detachably combined into a whole, and openings of receiving chambers of the plurality of layers of said frame are arranged on a same side of the frame.

In the second aspect, the present disclosure provides a liquid transfer system. The liquid transfer system includes a liquid transfer device and a solvent storage device according to the first aspect described above, wherein the liquid transfer device is configured to transfer liquid from a container stored in the solvent storage device.

A solvent storage device according to an embodiment of the present disclosure is provided with at least one layer of a frame which has a receiving chamber with an opening. A container carrying assembly for carrying containers is arranged in the receiving chamber, and the container carrying assembly is provided with a plurality of container placement parts. The container carrying assembly is connected to the frame through a first moving mechanism for driving the container carrying assembly to move in a straight line at the opening. According to the solvent storage device of an embodiment of the present disclosure, the first moving mechanism can drive the container carrying assembly to move in a straight line at the opening, for example, to move towards the outside of the receiving chamber or towards the inner side of the receiving chamber through the opening, which makes the liquid transfer operation more convenient. A plurality of containers in each layer of frame can be stably placed on the container carrying assembly, thus more containers can be stored in the space with same size and the space occupied by the containers can be reduced.

Furthermore, a container sealing assembly is arranged in the receiving chamber and is connected to the frame through a second moving mechanism. The container sealing assembly includes a sealing mechanism corresponding to the container placement part, and the second moving mechanism is configured to drive the sealing mechanism to be close to or away from the container placement part so as to make the sealing mechanism be in seal fit with or separate from a mouth of the container. In the process of liquid transfer, it is not required to open and seal the plurality of containers one by one, and the operating time of the liquid transfer process can be reduced.

It should be understood that the foregoing general description and the following detailed description are illustrative and explanatory only, and do not limit the present disclosure.

### BRIEF DESCRIPTION OF THE DRAWINGS

By providing a more detailed description of the exemplary embodiments of the present disclosure in combination with the accompanying drawings, the above and other purposes, features, and advantages of the present disclosure will become more apparent. In the exemplary embodiments of the present disclosure, the same reference numerals usually represent the same component.

FIG. 1 is a main view of the solvent storage device according to an embodiment of the present disclosure;

FIG. 2 is a top view of the solvent storage device shown in FIG. 1, with the container sealing assembly removed;

FIG. 3 is a three-dimensional view of the solvent storage device shown in FIG. 1, with the container sealing assembly removed;

FIG. 4 is a main view of the container sealing assembly of the solvent storage device shown in FIG. 1;

FIG. 5 is a top view of the container sealing assembly shown in FIG. 4;

FIG. 6 is a cross-sectional view along the line A-A in FIG. 5;

FIG. 7 is a partially enlarged view of the position B in FIG. 6;

FIG. 8 is a three-dimensional view of a solvent storage device according to another embodiment of the present disclosure;

FIG. 9 is a main view of the solvent storage device shown in FIG. 8.

### REFERENCE NUMERALS

100: frame; 110: bottom plate; 120: side plate; 130: back plate; 150: receiving chamber; 111: first photoelectrical switch; 131: second photoelectrical switch; 200: container carrying assembly; 210: transverse moving plate; 220: container limit plate; 221: container placement part; 222: container; 2221: container mouth; 300: first moving mechanism; 310: transverse guide rail; 320: first motor; 330: first drive rod; 400: second moving mechanism; 410: longitudinal guide rail; 420: second motor; 430: second drive rod; 500: container sealing assembly; 510: longitudinal moving plate; 520: mounting plate; 530: sealing mechanism; 531: guide column; 532: support sheet; 533: sealing sheet; 534: first fastener; 535: second fastener; 536: spring; 537: first gasket; 538: second gasket

### DETAILED DESCRIPTION OF THE EMBODIMENTS

Some embodiments of the present disclosure will be described in more detail below with reference to the accompanying drawings. Although some embodiments of the present disclosure are shown in the accompanying drawings, it should be understood that the present disclosure can be implemented in various forms and should not be limited by the embodiments described here. On the contrary, these embodiments are provided to make the present disclosure more thorough and complete, and to fully convey the scope of the present disclosure to ones skilled in the art.

It should be understood that although the terms “first,” “second,” “third,” etc. may be used in the present disclosure to describe various information, the information should not be limited to these terms. These terms are only used to distinguish the same type of information from each other. For example, without departing from the scope of the present disclosure, first information can also be referred to as second information, and similarly, second information can also be referred to as first information. Therefore, a feature defined as “first” or “second” can explicitly or implicitly include one or more of that feature. In the description of the present disclosure, “a plurality of” means two or more, unless otherwise specified.

In the description of the present disclosure, it should be understood that the terms “length”, “width”, “up”, “down”, “front”, “back”, “left”, “right”, “vertical”, “horizontal”, “top”, “bottom”, “inside”, “outside”, etc. indicate the orientation or positional relationship based on the orientation or positional relationship shown in the accompanying drawings, only for the convenience of describing the present disclosure and simplifying the description, rather than indicating or implying that the device or component referred to must have a specific orientation, be constructed and operated in a specific orientation, and therefore it cannot be understood as a limitation to the present disclosure.

Unless otherwise specified and limited, the terms “installation”, “couple”, “connection”, “fixation” or the like should be broadly understood. For example, the term “connection” can be a fixed connection, a detachable connection or as a whole, or can be a mechanical connection or an electrical connection, or can be directly connected or indirectly connected through an intermediate medium, or can be an internal connection between two components or an interaction relationship between two components. To a person skilled in the art, the specific meanings of the above terms in the present disclosure can be understood based on specific circumstances.

In the process of automated biochemical sample preparation and analysis, it is often necessary to use a liquid transfer pump to transfer liquid from a container. The process of liquid transfer involves operations such as taking and opening of bottles, liquid pump-out, and closing and placing of the bottles. As the number of types of solvent increases, more containers need to be used, resulting in a larger space occupied by the containers. Moreover, operating a plurality of containers one by one lead to longer liquid transfer time. To solve the above problems, a solvent storage device and a liquid transfer system are provided to reduce the space occupied by a plurality of containers and make the liquid transfer operation more convenient.

Technical solutions according to some embodiments of the present disclosure will be described in detailed in combination with the accompanying drawings.

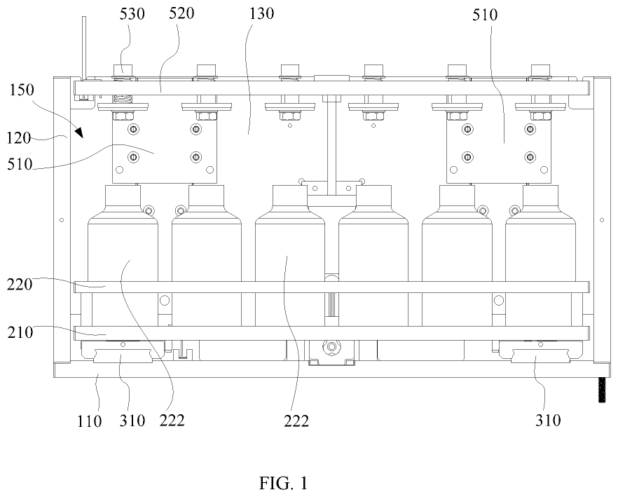

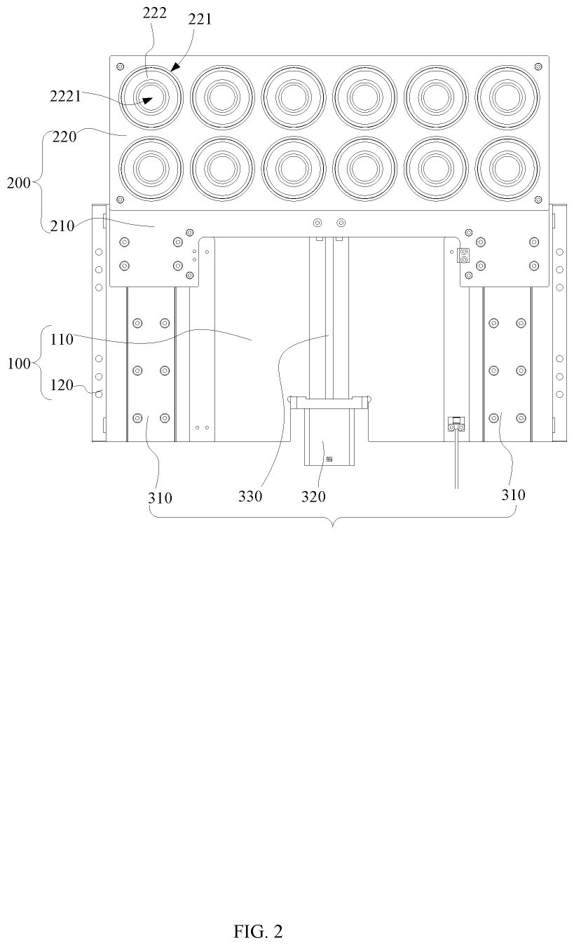

FIG. 1 is a main view of the solvent storage device according to an embodiment of the present disclosure. FIG. 2 is a top view of the solvent storage device shown in FIG. 1, with the container sealing assembly removed.

Referring to FIGS. 1 and 2, a solvent storage device according to an embodiment of the present disclosure is provided with at least one layer of a frame 100 which has a receiving chamber with an opening. A container carrying assembly 200 for carrying containers 222 is arranged in the receiving chamber. The container carrying assembly 200 is provided with a plurality of container placement parts 221. The container carrying assembly 200 is connected to the frame 100 through a first moving mechanism 300 for driving the container carrying assembly 200 to move in a straight line at the opening.

According to the solvent storage device of an embodiment of the present disclosure, a plurality of containers 222 in each layer of frame 100 can be stably placed on the container carrying assembly 200. The plurality of containers 222 can be stored. More containers 222 can be stored in the space with same size. The first moving mechanism 300 can drive the container carrying assembly 200 to move in a straight line at the opening. For example, the first moving mechanism 300 can drive the container carrying assembly 200 to move in a straight line towards the outside of the receiving chamber or towards the inner side of the receiving chamber at the opening, that is, to enter or exit at the opening, which makes the liquid transfer operation more convenient.

The container 222 of this embodiment can be in the shape of a bottle. Solvent for biochemical experiments is accommodated in the container 222. The plurality of containers 222 can accommodate different types of solvents. The upper part of the container 222 has a mouth 2221. A liquid transfer component can be extended into the container 222 from the mouth 2221 to transfer liquid. The liquid transfer component can be a liquid transfer pump, a liquid transfer gun or the like.

As the container carrying assembly 200 is provided with a plurality of container placing portions 221, the plurality of containers 222 can be limited to the plurality of container placing portions 221 of the container carrying assembly 200. When the container carrying assembly 200 moves, the plurality of containers 222 can remain stable.

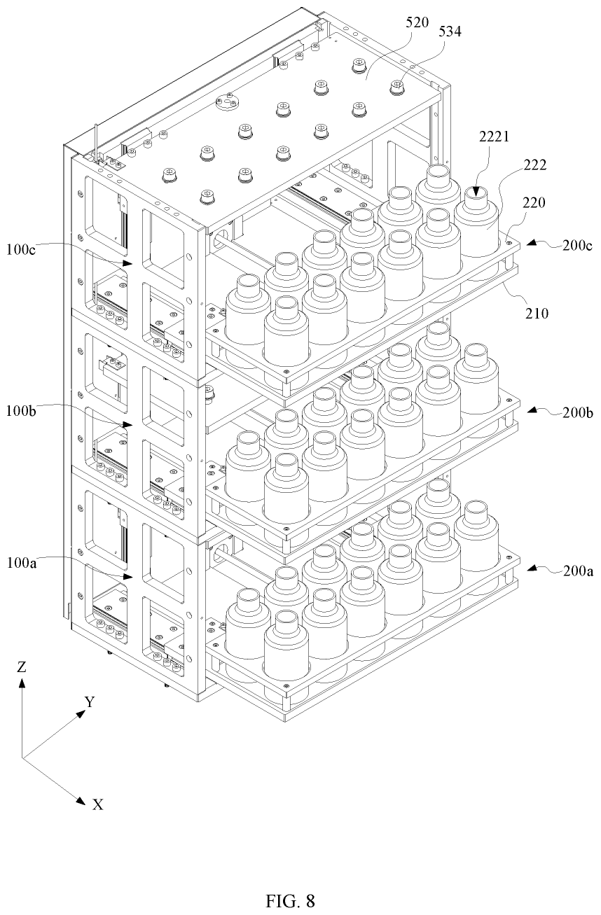

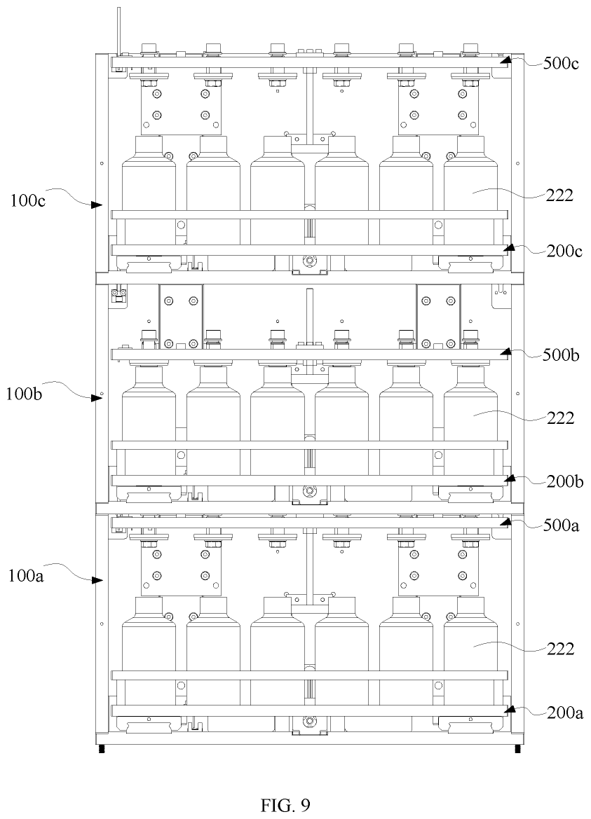

FIG. 8 is a three-dimensional view of a solvent storage device according to another embodiment of the present disclosure. FIG. 9 is a main view of the solvent storage device shown in FIG. 8.

Referring to FIGS. 8 and 9, according to some embodiments, the solvent storage device is provided with a plurality of layers of frame which are stacked along the longitudinal direction Z and are fixedly or detachably combined into a whole. For example, as shown in FIGS. 8 and 9, the solvent storage device is provided with three frames, namely the frame 100a, the frame 100b, and the frame 100c. The three frames are stacked along the longitudinal direction Z. The frame 100a is equipped with the container carrying assembly 200a and the container sealing assembly 500a, the frame 100b is equipped with the container carrying assembly 200b and the container sealing assembly 500b, and the frame 100c is equipped with the container carrying assembly 200c and the container sealing assembly 500c.

The openings of the receiving chambers of the frame 100a, the frame 100b, and the frame 100c are arranged on the same side so as to facilitate conducting liquid transfer operations on the same side. The layer number of the frame can be selected according to actual needs so as to store different numbers of containers 222.

In some embodiments, in the case that a plurality of layers of frame are provided, the plurality of layers of frame are sequentially connected in the vertical direction. The bottom plate of the upper frame (such as the frame 100b) is supported on the top of the lower frame (such as the frame 100a), and a top plate can be provided on the top of the uppermost frame (such as the frame 100c). The top plate is provided with several positioning members. The positioning member is configured to be in limiting cooperation with a support for another container placed on the top plate. As an example, said another container can be a test tube for accommodating reagents.

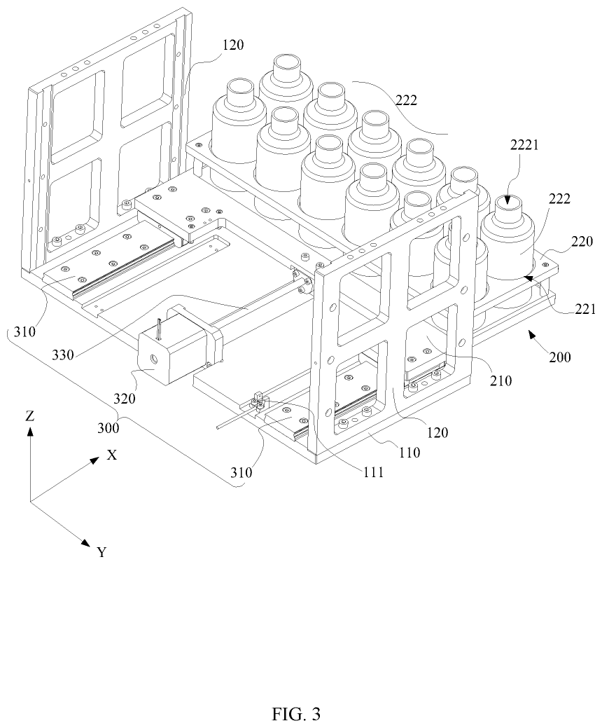

Referring to FIGS. 3, 4 and 8, in this embodiment, the frame 100 is formed by assembling a plurality of plates together. For example, the frame 100 can include a bottom plate 110, a top plate (not shown, can be defaulted), a back plate 130 and two side plates 120 connected between the bottom plate 110 and the top plate-. The bottom plate 110, the top plate, the back plate 130 and the two side plates 120 define the receiving chamber, and the opening of the receiving chamber is formed on the opposite side of the back plate 130. For example, the opening can be arranged towards the transverse direction X. The container carrying assembly 200 can move from the opening towards the inside or outside of the receiving chamber. After the container carrying assembly 200 moves towards the inside of the receiving chamber, the plurality of containers 222 can be stored in the receiving chamber. After the container carrying assembly 200 moves towards the outside of the receiving chamber, it is convenient to perform liquid transfer operations of the containers 222. In this embodiment, the container carrying assembly 200 is connected to the frame 100 through the first moving mechanism 300. The first moving mechanism can drive the container carrying assembly 200 to move. Continuing with FIGS. 2 and 3, in an implementation, the first moving mechanism 300 includes a first guide component and a first drive assembly. The container carrying assembly 200 is slidably connected to the first guide component. The first drive assembly is in transmission connection with the container carrying assembly 200 to drive the container carrying assembly 200 to move, enabling the plurality of containers 222 on the container carrying assembly 200 to move together to the outside or inside of the receiving chamber.

In some embodiments, the first guide component includes two transverse guide rails 310 laid on the bottom plate 110 of the frame 100 in parallel. The two transverse guide rails 310 have an inner end and an outer end. The inner end is arranged near the back plate 130 of the frame 100, and the outer end extends to the opening of the receiving chamber. Two transverse guide rails 310 are both arranged in the receiving chamber along the transverse direction X and near the side plates 120 at both sides respectively. The container carrying assembly 200 is slidably connected to and supported on the two transverse guide rails 310.

Continuing with FIG. 3, in some embodiments, the first drive assembly includes a first motor 320 and a first drive rod 330 that cooperates with the first motor 320 in a transmission manner. The first motor 320 can be a linear stepper motor, and the linear stepper motor can drive the first drive rod 330 to move in a straight line along its axis (i.e. the direction X). The first motor 320 is fixed relative to the frame 100. For example, the first motor can be fixed to the frame 100 through a fixing member, such as a motor fixing seat.

The first drive rod 330 is connected to the container carrying assembly 200. Specifically, the first drive rod 330 is connected to the lower side of the container carrying assembly 200 to drive the container carrying assembly 200 to move along the transverse direction X. As the plurality of containers 222 is stable relative to the container carrying assembly 200 after being limited to the container carrying assembly 200, the plurality of containers 222 can move together with the first drive rod 330. When the first drive rod 330 drives the container carrying assembly 200 to move towards the outside of the opening, the plurality of containers 222 and the container carrying assembly 200 move to the outside of the receiving chamber. When the first drive rod 330 drives the container carrying assembly 200 to move towards the inside of the opening, the plurality of containers 222 and the container carrying assembly 200 move into the receiving chamber.

In some embodiments, in order to ensure that the container carrying assembly 200 can smoothly slide on the first guide component and avoid collision or detachment, the frame 100 is also equipped with a first limit component which is used to limit the operation of the container carrying assembly 200 so as to limit the container carrying assembly 200 to a predetermined position of the inner side or the outer side of the receiving chamber.

In an implementation, the first limit component can include a first photoelectric switch 111 and a limit screw. The first photoelectric switch 111 is arranged near the inner end of the transverse guide rail 310. The photoelectric switch can sense the position of the transverse moving plate 210 moving towards the inside of the receiving chamber, so that the transverse moving plate 210 stops after moving to a specific position in the receiving chamber. The limit screw is arranged near the outer end of the transverse guide rail 310. When the container carrying assembly 200 moves towards the outside of the receiving chamber, the limit screw can stop the container carrying assembly 200, thereby making the container carrying assembly 200 stop at the set position outside the receiving chamber.

In some embodiments, the container carrying assembly 200 includes a transverse moving plate 210 and a container limit plate 220 installed above the transverse moving plate 210. The transverse moving plate is slidably connected to the first guide component. For example, a slider can be installed on the transverse guide rails 310, and the transverse moving plate 210 is fixed on the slider and is able to slide along the two transverse guide rails 310 with the slider. Continuing with FIG. 3, the container limit plate 220 is spaced from the transverse moving plate 210 in the vertical direction, that is, the container limit plate 220 and the transverse moving plate 210 have a set spacing in the longitudinal direction Z. The container limit plate 220 and the transverse moving plate 210 are in parallel and fixedly connected to each other through a plurality of columns. The container placement parts 221 has a plurality of limit holes formed in the container limit plate 220. The containers 222 can be placed and limited in the limit holes, and the bottom of the container 222 can be supported on the upper surface of the transverse moving plate 210.

The limit hole can be a through hole that passes through the upper and lower sides of the container limit plate 220. The shape of the limit hole matches the cross-sectional shape of the container 222. For example, in the case that the cross-sectional shape of the container 222 is circular, the limit hole can also be set as circular.

When the container 222 is placed in the limit hole, the bottom of the container 222 can be supported on the upper surface of the transverse moving plate 210, and the side wall of the container 222 can be abutted against the wall of the limit hole, thereby limiting the position of the container 222.

In some embodiments, the first drive rod 330 can be a telescopic rod which is telescopic in the direction of movement of the container carrying assembly 200. The transverse moving plate 210 can be fixedly connected to the telescopic rod. When the first motor 320 is in operation, the first motor 320 can drive the telescopic rod to stretch out or draw back, thereby driving the transverse moving plate 210 to move.

In some embodiments, the first drive rod 330 can be a screw rod. A nut is sleeved on the screw rod and is connected to the transverse moving plate 210. When the first motor 320 is in operation, the first motor 320 can drive the screw rod to rotate, thereby causing the nut to slide along the screw rod to drive the transverse moving plate 210 to move.

It can be understood that it is not limited to drive the first drive rod 330 by the first motor 320. In some other embodiments, the first drive rod 330 can alternatively be driven by a cylinder.

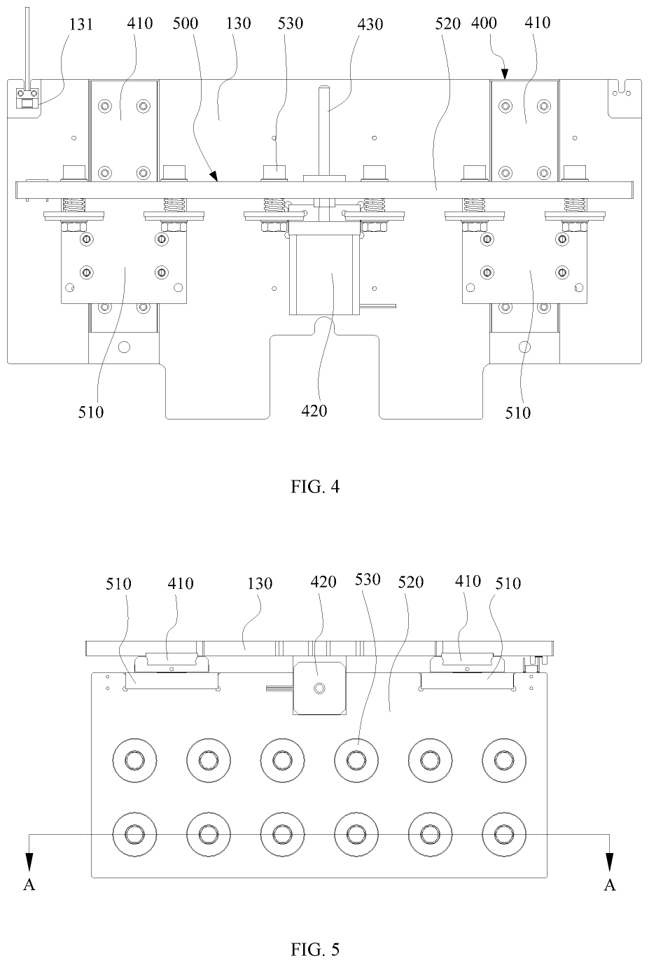

Referring to FIGS. 1 and 4, in some embodiments, in order to enable the plurality of containers 222 to be opened or sealed simultaneously, a container sealing assembly 500 is further arranged in the receiving chamber. The container sealing assembly 500 is connected to the frame 100 through a second moving mechanism 400. The container sealing assembly 500 is arranged above the container carrying assembly 200. The container sealing assembly 500 includes sealing mechanisms 530 corresponding to the container placement parts 221 along the longitudinal direction Z. The second moving mechanism 400 is configured to drive the sealing mechanisms 530 to be close to or away from the container placement parts 221 so as to make the sealing mechanisms 530 be in seal fit with or detach from the mouths 2221 of the containers 222.

When a liquid transfer operation is required, the second moving mechanism 400 drives the container sealing assembly 500 to rise, making the sealing mechanisms 530 separate from the mouths 2221 of the containers 222. Then, the first moving mechanism 300 drives the container carrying assembly 200 to move to the outside the receiving chamber so that the liquid transfer pump can be extended into the container mouths 2221 for liquid transfer. After the liquid transfer is completed, the first moving mechanism 300 drives the container carrying assembly 200 to move to the inside of the receiving chamber. Then, the second moving mechanism 400 drives the container sealing assembly 500 to descend so that the sealing mechanisms 530 are engaged with the mouths 2221 of the containers 222, thus the plurality of containers 222 are in a sealed state again.

According to the solvent storage device of some embodiments of the present disclosure, it is not required to open and seal the plurality of containers 222 one by one during biochemical experiments. For example, there is no need to perform operations such as taking and opening of bottles, liquid pump-out, and closing, and placing of the bottles one by one. The operating time of the liquid transfer process can be reduced.

Referring to FIG. 4, in some embodiments, the second moving mechanism 400 includes a second guide component and a second drive assembly, and the container sealing assembly 500 is slidably connected to the second guide component. The second drive assembly is in transmission connection with the container sealing assembly 500 to drive the container sealing assembly 500 to move. The second guide component can include two longitudinal guide rails 410 in parallel. The two longitudinal guide rails 410 are arranged along the longitudinal direction Z and can be installed at the inner side of the back plate 130 of the frame 100. A slider can be installed on the longitudinal guide rails 410, and the container sealing assembly 500 is fixed on the slider and is able to slide along the two longitudinal guide rails 410 with the slider.

In some embodiments, the second drive assembly includes a second motor 420 and a second drive rod 430 that cooperates with the second motor in a transmission manner. The second motor 420 is fixed to the frame 100. The second drive rod 430 is arranged along the longitudinal direction Z and fixedly connected to the longitudinal moving plate 510.

In some embodiments, the second drive rod 430 can be a telescopic rod which is telescopic in the direction of movement of the container sealing assembly 500. The longitudinal moving plate 510 can be fixedly connected to the telescopic rod. When the second motor 420 is in operation, the second motor 420 can drive the telescopic rod to stretch out or draw back, thereby driving the longitudinal moving plate 510 to move.

In some embodiments, the second drive rod 430 can be a screw rod. A nut is sleeved on the screw rod and is connected to the longitudinal moving plate 510. When the second motor 420 is in operation, the second motor 420 can drive the screw rod to rotate, thereby causing the nut to slide along the screw rod to drive the longitudinal moving plate 510 to move.

It can be understood that it is not limited to drive the second drive rod 430 by the second motor 420. In some other embodiments, the second drive rod 430 can alternatively be driven by a cylinder.

The second motor 420 of this embodiment can be a linear stepper motor, and the second motor 420 can drive the second drive rod 430 to move in a straight line along its axis. The second motor 420 is fixed relative to the frame 100. For example, the second motor 420 can be fixed to the frame 100 through a fixing member.

In some embodiments, the solvent storage device further includes a second limit component mounted to the frame 100. The second limit component is used to limit the movement of the container sealing assembly 500 so as to limit the container sealing assembly to a predetermined position along the longitudinal movement. The second limit component can include a second photoelectric switch 131 and a limit screw. The second photoelectric switch 131 is installed near the upper end of the longitudinal guide rail 410 and can limit the upward movement of the longitudinal moving plate 510. When the container sealing assembly 500 moves downwards, the limit screw can stop the container sealing assembly 500 at the set position such that the sealing mechanism 530 can descend to a height that matches the height of the container and therefore can be in seal fit with the mouth 2221 of the container.

Referring to FIG. 4, in some embodiments, the container sealing assembly 500 includes a longitudinal moving plate 510 and a mounting plate 520 installed to the longitudinal moving plate 510. The longitudinal moving plate 510 is slidably limited to the second guide component, and the second drive assembly is in transmission connection with the longitudinal moving plate 510. The plurality of sealing mechanisms 530 are fixed to the mounting plate 520 and can move with the mounting plate 520 along the longitudinal direction Z.

Referring to FIGS. 2 and 5, in some embodiments, the arrangement of the plurality of sealing mechanisms 530 on the mounting plate 520 matches the arrangement of the plurality of container placing portions 221 on the container carrying assembly 200, resulting in a one-to-one correspondence between the plurality of sealing mechanisms 530 and the plurality of container placing portions 221. For example, in the case that the plurality of container placing portions 221 are arranged on the container carrying assembly 200 in a rectangular array shape, the plurality of sealing mechanisms 530 are also arranged on the mounting plate 520 in a rectangular array shape. When the second moving mechanism 400 drives the longitudinal moving plate 510 to descend, the plurality of sealing mechanisms 530 on the mounting plate 520 are engaged with the mouths 2221 of the containers in a one-to-one correspondence manner, thereby achieving simultaneous sealing or opening of the mouths 2221 of the plurality of containers, thus the defect of longer liquid transfer time because of requiring to open and seal the plurality of containers one by one in the related art can be avoided, and the operation speed of liquid transfer can be increased.

It can be understood that the first motor 320 and the transverse guide rail 310 can be arranged on the bottom plate 110 of the frame 100 or on the side plate 120 of the frame 100. The second motor 420 and the longitudinal guide rail 410 can be arranged on the back plate 130 of the frame 100 or on the side plate 120 of the frame 100, which are not specifically limited here.

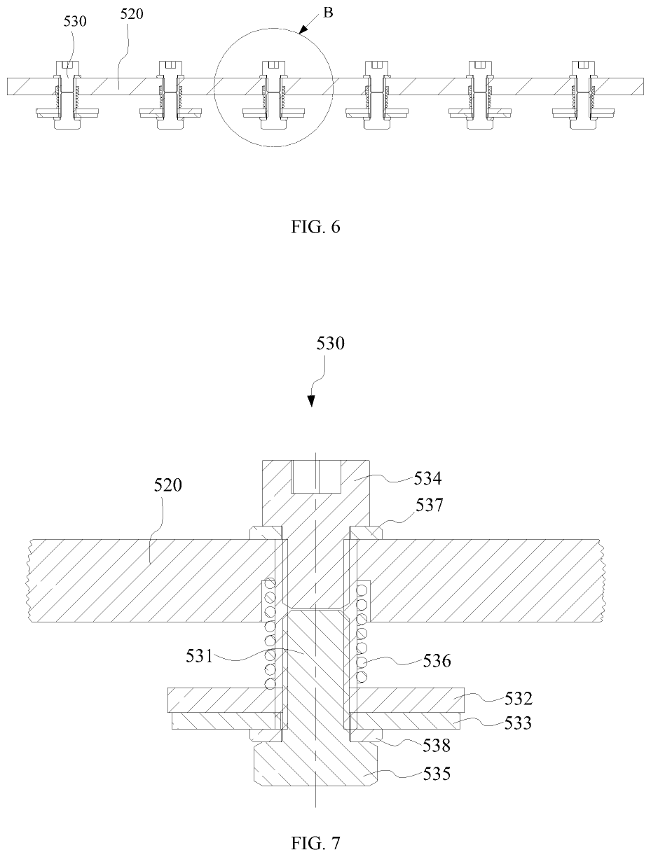

FIG. 6 is a cross-sectional view along the line A-A in FIG. 5. FIG. 7 is a partially enlarged view of the position B in FIG. 6.

Referring to FIGS. 4, 6, and 7, in this embodiment, the sealing mechanism 530 includes a guide column 531 installed to the mounting plate 520. The guide column 531 extends along the longitudinal direction Z. A sealing component is sleeved on the guide column 531. The sealing component is arranged corresponding to the container placing portion 221 and is configured to be in seal fit with the mouth 2221 of the container 222. After the mounting plate 520 descends to the set position, the sealing component can make close contact with the edge of the mouth 2221 of the container and maintain a certain pressure.

In some embodiments, the sealing component is movably arranged along the axial direction of the guide column 531, and an elastic member 536 is further sleeved on the guide column 531. The elastic member 536 is arranged between the mounting plate 520 and the sealing component. Both ends of the elastic member 536 are abutted against the mounting plate 520 and the sealing component respectively. When the sealing component makes contact with the container mouth 2221, the elastic member 536 can apply downward pressure to the sealing component, thereby ensuring more stable contact between the sealing component and the container mouth 2221.

In this embodiment, the elastic member 536 can be a spring sleeved on the guide column 531. However, the elastic member 536 is not limited to a spring. Alternatively, it can be other elastic components with functions similar to the spring, such as a rubber ring.

In some embodiments, the sealing component includes a support sheet 532 sleeved on the guide column 531 and a sealing sheet 533 tightly engaged with the support sheet 532. Both ends of the elastic member 536 are abutted against the mounting plate 520 and the support sheet 532 respectively. The elastic member 536 can apply downward pressure on the sealing sheet 533 through the support sheet 532, thus adjustable compression force between the sealing sheet 533 and the container mouth 2221 can be achieved.

In some embodiments, the support plate 532 can be made of a rigid material, such as stainless steel. The sealing sheet 533 can be made of flexible material with good acid and alkali corrosion resistance, such as silicone or Poly tetra fluoroethylene (PTFE).

Continuing with FIG. 7, in some embodiments, a plurality of mounting holes are formed in the mounting plate 520, and the guide columns 531 of the plurality of sealing mechanisms 530 are installed in the mounting holes. The upper end of the guide column 531 is connected with the first fastener 534. The first fastener 534 presses against the upper side of the mounting plate 520. The lower end of the guide column 531 is connected with the second fastener 535. The sealing component is sandwiched between the second fastener 535 and the elastic member 536, making the guide column 531 fixed to the mounting plate 520.

In this embodiment, the guide column 531 is in a hollow shape. Threaded holes are provided at both axial ends of the guide column 531. The first fastener 534 and the second fastener 535 can be bolts that can match the threaded holes. In an implementation, the first fastener 534 can be an inner hexagonal bolt, and the second fastener 535 can be an outer hexagonal bolt. Considering that the second fastener 535 will be in contact with the container mouth 2221, in order to ensure its good acid and alkali corrosion resistance, the second fastener 535 is preferably an outer hexagonal bolt made of PTFE.

In some embodiments, in order to improve the stability of the fit between the first fastener 534 and the mounting plate 520, a first gasket 537 can be arranged between the first fastener 534 and the mounting plate 520. In order to improve the stability of the fit between the second fastener 535 and the sealing component, a second gasket 538 can be arranged between the second fastener 535 and the sealing component. Considering that the second gasket 538 will be in contact with the container mouth 2221, in order to ensure its good acid and alkali corrosion resistance, the second gasket 538 is preferably made of PTFE.

It can be seen from the above embodiments that in the case that there are a large number of containers 222, the containers 222 can be placed in layers in a plurality of layers of frame 100. The container carrying assembly 200 and the container sealing assembly 500 of each layer of frame 100 can operate independently, and liquid transfer can be carried out in one or more layers of containers 222 according to actual needs, making the transfer operation more convenient. In addition, the frames 100 are detachably connected, allowing for the selection of a single layer or a plurality of layers of frame 100 according to actual needs, thereby meeting the needs of different biochemical sample preparation and analysis experiments for the number of containers and reducing the space occupation of the containers.

It can be understood that the frame 100 can be composed of a bottom plate 110, two side plates 120, and a back plate 130. The bottom plate 110, the two side plates 120, the back plate 130 and the mounting plate 520 define the receiving chamber with adjustable space. Optionally, a top plate is fixedly arranged above the mounting plate 520, a positioning member is arranged on the top plate, which is used for placing other containers or equipment, such as a tray rack with test tubes or a tray rack with tip head, thus the space utilization of the solvent storage device can be further improved.

The solvent storage devices according to some embodiments of the present disclosure have been introduced. Accordingly, a liquid transfer system is also provided in the present disclosure. The liquid transfer system includes a liquid transfer device and a solvent storage device as described in any of the above embodiments. The liquid transfer device is configured for transferring liquid from a container stored in the solvent storage device.

In some embodiments, the liquid transfer device can be a robotic arm with a liquid transfer gun or a liquid transfer pump, and fully automated operation of the liquid transfer process can be achieved. The structure of the solvent storage device can refer to the above-described embodiments and will not be repeatedly described here.

Various embodiments of the present disclosure have been described above. The above description is exemplary but not exhaustive, and the present disclosure is not limited to the disclosed embodiments. Without deviating from the scope and spirit of the various embodiments illustrated, many modifications and changes are obvious to a person skilled in the art. The selection of terms used in this text aims to best explain the principles, the practical applications of various embodiments, or the improvements to the technologies in the market, or to enable other ordinary technical persons in the art to understand the disclosed embodiments.

1. A solvent storage device, wherein:
the solvent storage device is provided with at least one layer of a frame which has a receiving chamber with an opening, a container carrying assembly for carrying containers is arranged in the receiving chamber, and the container carrying assembly is provided with a plurality of container placement parts;
wherein the container carrying assembly is connected to the frame through a first moving mechanism for driving the container carrying assembly to move in a straight line at the opening.

2. The solvent storage device according to claim 1, wherein:
a container sealing assembly is arranged in the receiving chamber and is connected to the frame through a second moving mechanism;
wherein the container sealing assembly comprises a sealing mechanism corresponding to the container placement part, and the second moving mechanism is configured to drive the sealing mechanism to be close to or away from the container placement part so as to make the sealing mechanism be in seal fit with or separate from a mouth of the container.

3. The solvent storage device according to claim 2, wherein:
the first moving mechanism comprises a first guide component and a first drive assembly, the container carrying assembly is slidably connected to the first guide component, and the first drive assembly is in transmission connection with the container carrying assembly to drive the container carrying assembly to move.

4. The solvent storage device according to claim 3, wherein:
the container carrying assembly comprises a transverse moving plate and a container limit plate installed above the transverse moving plate, the transverse moving plate is slidably connected to the first guide component, and the first drive assembly is in transmission connection with the transverse moving plate;
wherein the container placement part includes a limit hole formed in the container limit plate, and the container is placed in the limit hole and supported on the transverse moving plate.

5. The solvent storage device according to claim 2, wherein:
the second moving mechanism comprises a second guide component and a second drive assembly, the container sealing assembly is slidably connected to the second guide component, and the second drive assembly is in transmission connection with the container sealing assembly to drive the container sealing assembly to move;
the container sealing assembly comprises a longitudinal moving plate and a mounting plate installed to the longitudinal moving plate, the longitudinal moving plate is slidably connected to the second guide component, the second drive assembly is in transmission connection with the longitudinal moving plate, and the sealing mechanism is installed to the mounting plate.

6. The solvent storage device according to claim 5, wherein:
the sealing mechanism comprises a guide column installed to the mounting plate, the guide column has a sealing component installed thereon, the sealing component is arranged corresponding to the container placement part and is configured to be engaged with the mouth of the container.

7. The solvent storage device according to claim 6, wherein:
the sealing component is movably arranged along an axial direction of the guide column, an elastic member is sleeved on the guide column, and both ends of the elastic member are abutted against the mounting plate and the sealing component respectively.

8. The solvent storage device according to claim 7, wherein:
the sealing component comprises a support sheet sleeved on the guide column and a sealing sheet tightly engaged with the support sheet, and the both ends of the elastic member are abutted against the mounting plate and the support sheet respectively;
wherein the sealing sheet is located below the support sheet, and a lower surface of the sealing sheet is configured to be engaged with the mouth of the container.

9. The solvent storage device according to claim 7, wherein:
the mounting plate has a mounting hole formed therein, the guide column is installed in the mounting hole, an upper end of the guide column is connected to a first fastener, the first fastener presses against an upper side of the mounting plate, a lower end of the guide column is connected to a second fastener, the sealing component is sandwiched between the second fastener and the elastic member, and the second fastener presses against one side of the sealing component that is away from the elastic member.

10. The solvent storage device according to claim 43, wherein:
the first drive assembly comprises a first motor and a first drive rod that cooperates with the first motor in a transmission manner, the first motor is fixed to the frame, and the first drive rod is arranged horizontally and connected to the transverse moving plate to drive the transverse moving plate to move.

11. The solvent storage device according to claim 2, wherein:
the container sealing assembly is provided with a plurality of said sealing mechanisms which are in one-to-one correspondence with to a plurality of said container placement parts.

12. The solvent storage device according to claim 4, wherein:
the container limit plate is spaced from the transverse moving plate in a vertical direction; wherein when the container is placed in the limit hole, a bottom of the container is supported on an upper surface of the transverse moving plate and an outer side wall of the container presses against a wall of the limit hole.

13. The solvent storage device according to claim 3, wherein:
the frame comprises a bottom plate, a top plate, and a side plate and a back plate connected between the bottom plate and the top plate, wherein the bottom plate, the top plate, the side plate, and the back plate define the receiving chamber, and the opening is arranged on an opposite side of the back plate.

14. The solvent storage device according to claim 1, wherein:
the solvent storage device is provided with a plurality of layers of said frame which are fixedly or detachably combined into a whole, and openings of receiving chambers of the plurality of layers of said frame are arranged on a same side of the frame.

15. A liquid transfer system, comprising:
a liquid transfer device and a solvent storage device according to claim 1, wherein the liquid transfer device is configured to transfer liquid from a container stored in the solvent storage device.

16. The solvent storage device according to claim 2, wherein:
the second moving mechanism comprises a second guide component and a second drive assembly, the container sealing assembly is slidably connected to the second guide component, and the second drive assembly is in transmission connection with the container sealing assembly to drive the container sealing assembly to move.

17. The solvent storage device according to claim 3, wherein:
the second moving mechanism comprises a second guide component and a second drive assembly, the container sealing assembly is slidably connected to the second guide component, and the second drive assembly is in transmission connection with the container sealing assembly to drive the container sealing assembly to move.

18. The solvent storage device according to claim 5, wherein:
the second drive assembly comprises a second motor and a second drive rod that cooperates with the second motor in a transmission manner, the second motor is fixed to the frame, and the second drive rod is arranged longitudinally and connected to the longitudinal moving plate to drive the longitudinal moving plate to move.

19. The solvent storage device according to claim 10, wherein:
the container sealing assembly comprises a longitudinal moving plate and a mounting plate installed to the longitudinal moving plate, the longitudinal moving plate is slidably connected to the second guide component, the second drive assembly is in transmission connection with the longitudinal moving plate, and the sealing mechanism is installed to the mounting plate;
the second drive assembly comprises a second motor and a second drive rod that cooperates with the second motor in a transmission manner, the second motor is fixed to the frame, and the second drive rod is arranged longitudinally and connected to the longitudinal moving plate to drive the longitudinal moving plate to move.
